(19) United States
(12) Patent Application Publication
(10) Pub. No.: US 2010/0284046 A1
(43) Pub. Date: Nov. 11, 2010

(54) IMAGE READING DEVICE AND IMAGE READING METHOD

(75) Inventors: Soon Keat Fah, Singapore (SG); Ng Chin Tak, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/776,206

(22) Filed: May 7, 2010

(30) Foreign Application Priority Data
May 8, 2009 (JP) 2009-113380

(51) Int. Cl. H04N 1/04

(52) U.S. Cl. 358/474

(57) ABSTRACT

An image reading device that optically reads an original sheet includes: an original sheet holder having a flat surface on which the original sheet is placed; an imaging unit that images a rectangular region that is included in the flat surface and is smaller than the flat surface; a moving unit that moves the imaging unit substantially along the flat surface in first and second directions that cross each other and places the imaging unit at a plurality of facing positions at which the imaging unit faces the flat surface; a route selector that selects, on the basis of the original sheet placed on the flat surface, a movement route along which the imaging unit is moved by the moving unit.

### BACKGROUND

1. Technical Field

The present invention relates to an image reading device (image scanner) that optically reads an original sheet.

2. Related Art

JP-A-5-145693 describes an image reading device having a line sensor (one-dimensional image sensor). The line sensor has a plurality of imaging elements arranged in a row. The line sensor reads a portion of an original sheet while moving from end to end of an original sheet holder in a direction perpendicular to a direction in which the imaging elements are arranged. Then, the line sensor moves in the direction in which the imaging elements are arranged and reads another portion of the original sheet while moving from end to end of the original sheet holder in the direction perpendicular to the direction in which the imaging elements are arranged. The image reading device is capable of reading an original sheet that is larger than an imaging area of the image sensor.

However, the operation for reading an original sheet that is larger than the imaging area of the image sensor has not been given sufficient consideration. The image sensor moves across the entire area of the original sheet holder regardless of the size of the original sheet. Thus, the time required to read an original sheet that is smaller than the original sheet holder is about the same as the time required to read an original sheet that is larger than the original sheet holder.

### SUMMARY

An advantage of some aspects of the invention is that it provides a technique for reading an original sheet at an increased rate.

The invention has been devised to solve at least one of the aforementioned problems and can be realized in the following embodiments and aspects.

According to a first aspect of the invention, an image reading device that optically reads an original sheet includes: an original sheet holder having a flat surface on which the original sheet is placed; an imaging unit that images a rectangular region that is included in the flat surface and is smaller than the flat surface; a movable unit that moves the imaging unit substantially along the flat surface in first and second directions that cross each other and places the imaging unit at a plurality of facing positions at which the imaging unit faces the flat surface; a route selector that selects, on the basis of the original sheet placed on the flat surface, a movement route along which the imaging unit is moved by the moving unit; and an image generator that generates, on the basis of imaging data on a plurality of rectangular regions imaged by the imaging unit and correspond to the respective facing positions, image data on the original sheet placed on the flat surface. The image reading device according to the first aspect is capable of reading the original sheet while moving the imaging unit along the movement route selected on the basis of the original sheet. The movement route is selected on the basis of the original sheet to allow the original sheet to be efficiently read, and the rate of reading the original sheet can be improved.

It is preferable that the imaging unit image each rectangular region while stopping at the facing position corresponding to the rectangular region. In this case, a failure in which the imaging unit (that images each rectangular region by means of an area sensor (two-dimensional image sensor)) does not image the original sheet can be avoided.

It is preferable that the imaging unit include a light emitting section that emits light toward the flat surface in synchronization with the imaging of each rectangular region. In this case, consumption power required for illuminating the original sheet can be suppressed compared with consumption power required for continuously illuminating the original sheet during the operation for reading the original sheet.

It is preferable that each rectangular region that is imaged by the imaging unit placed at the facing position corresponding to the rectangular region overlap other adjacent rectangular regions. In this case, reproducibility of the original sheet can be improved by the image data formed by combining image data on the rectangular regions.

It is preferable that the image reading device further include a preliminary image generator that generates preliminary image data on the flat surface imaged by the imaging unit before the selection of the movement route by the route selector, wherein the route selector selects, on the basis of the preliminary image data generated by the preliminary image generator, the movement route for the original sheet placed on the flat surface. In this case, since the original sheet can be confirmed on the basis of the preliminary image data before the selection of the movement route, the movement route can be easily selected.

It is preferable that the route selector select, on the basis of imaging data on the rectangular regions that are imaged by the imaging unit during the movement of the imaging unit by the moving unit and correspond to the respective facing positions, the movement route for the original sheet placed on the flat surface. In this case, the movement route can be selected while the original sheet is read.

It is preferable that the image reading device further include a shape information receiver that receives shape information on the shape of the original sheet placed on the flat surface before the selection of the movement route by the route selector, wherein the route selector selects, on the basis of the shape information received by the shape information receiver, the movement route for the original sheet placed on the flat surface. In this case, since the shape of the original sheet can be confirmed on the basis of the shape information before the selection of the movement route, the movement route can be easily selected.

It is preferable that the route selector include a first selector that selects, as at least a part of the movement route, a route that extends along a region in which the original sheet is placed on the flat surface. In this case, since the imaging unit can move while avoiding a region in which the original sheet is not placed on the flat surface, the rate of reading the original sheet can be further improved.

It is preferable that the route selector include a second selector that selects, as at least a part of the movement route, a route that continuously extends in the first or second direction on the basis of the shape of the original sheet placed on the flat surface. In this case, since the imaging unit can continuously move in a direction based on the shape of the original sheet placed on the flat surface, the rate of reading the original sheet can be further improved.

It is preferable that the route selector include a third selector that selects, as at least a part of the movement route, a route extending along a straight line that extends between the position of the original sheet placed on the flat surface and the position of the imaging unit. In this case, since the imaging unit moves a relatively short distance in a region in which the original sheet is not placed on the flat surface, the rate of reading the original sheet can be further improved.

According to a second aspect of the invention, an image reading method for optically reading an original sheet includes: placing the original sheet on a flat surface of an original sheet holder; moving, substantially along the flat surface in first and second directions that cross each other, an imaging unit that images a rectangular region that is smaller than the flat surface, and placing the imaging unit at a plurality of facing positions at which the imaging unit faces the flat surface; selecting, on the basis of the original sheet placed on the flat surface, a movement route along which the imaging unit moves; and generating image data on the original sheet placed on the flat surface by combining imaging data on a plurality of rectangular regions that are imaged by the imaging unit and correspond to the respective facing positions. In the method, the imaging unit can move along the movement route selected on the basis of the original sheet, and the original sheet can be read. The movement route is selected on the basis of the original sheet to allow the original sheet to be efficiently read, and the rate of reading the original sheet can be improved.

The aspects of the invention are not limited to the image reading device and the image reading method and may be applicable to a method for controlling the image reading device, a program that enables a computer to control the image reading device, and the like. The invention is not limited to the aforementioned aspects and can be realized in various embodiments without departing from the spirit of the invention.

### BRIEF DESCRIPTION OF THE DRAWINGS

The invention will be described with reference to the accompanying drawings, wherein like numbers reference like elements.

FIG. 1 is a diagram showing the outline configuration of an image scanner.

FIG. 2 is a diagram showing functional parts of the image scanner.

FIG. 3 is a diagram showing positional relationships between a transparent portion and rectangular regions.

FIG. 4 is a perspective view showing the configuration of an image reading unit in detail.

FIG. 5 is a diagram showing the configuration of an imaging section in detail.

FIG. 6 is a flowchart of an image reading control process that is performed by a main controller included in the image scanner.

FIG. 7 is a diagram showing an example of a movement route selected in a route selection process.

FIG. 8 is a diagram showing an example of the movement route selected in the route selection process according to a first modified example.

FIG. 9 is a diagram showing another example of the movement route selected in the route selection process according to the first modified example.

FIG. 10 is a diagram showing an example of the movement route selected in the route selection process according to a second modified example.

FIG. 11 is a flowchart of an image reading control process that is performed by the main controller included in the image scanner according to a second embodiment of the invention.

FIG. 12 is a flowchart of an image reading control process that is performed by the main controller included in the image scanner according to a third embodiment of the invention.

FIG. 13 is a diagram showing an example of movement routes according to another embodiment.

### DESCRIPTION OF EXEMPLARY EMBODIMENTS

An image reading device (image scanner) according to the invention is described below to clarify the configuration and operations of the image reading device.

### First Embodiment

### Configuration of Image Scanner

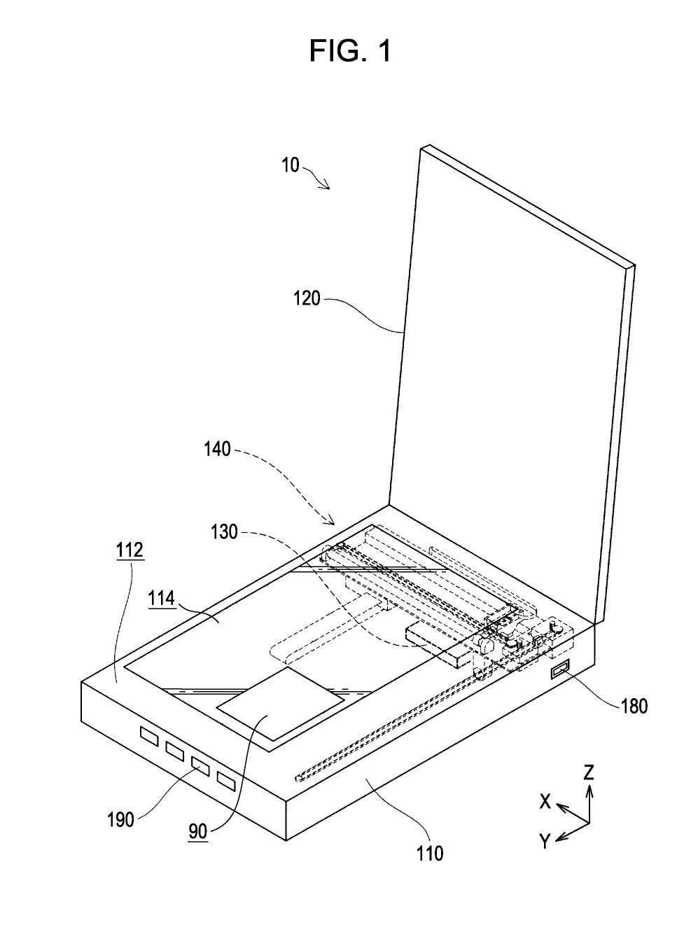

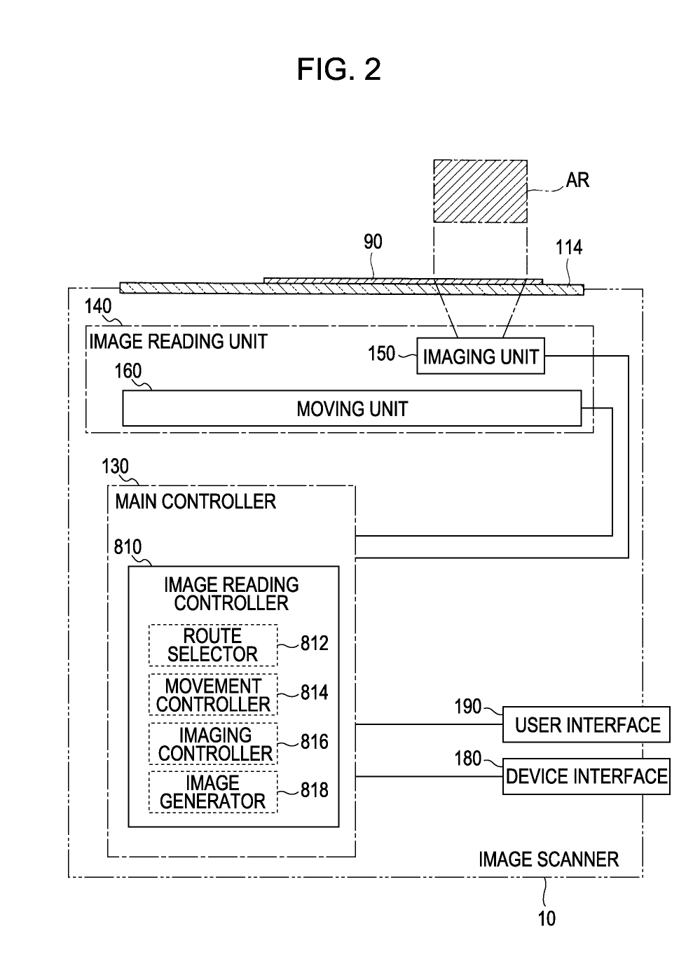

FIG. 1 is a diagram showing the outline configuration of an image scanner 10. FIG. 2 is a diagram showing functional parts of the image scanner 10. The image scanner 10 is a flat-bed image reading device. The image scanner 10 optically reads an original sheet 90 to generate image data. The image scanner 10 includes a housing body 110, a cover 120, a main controller 130, an image reading unit 140, a device interface 180 and a user interface 190.

The housing body 110 houses the main controller 130 and the image reading unit 140 and forms an original sheet holder 112. The original sheet 90 is placed on the original sheet holder 112. The housing body 110 has a transparent portion 114 made of a transparent material. The transparent portion 114 is a part of the original sheet holder 112. The transparent portion 114 has a flat surface on which the original sheet 90 is placed. In the present embodiment, the housing body 110 is formed in a rectangular box shape. The original sheet holder 112 is located on an upper surface of the housing body 110. The transparent portion 114 is made of colorless and transparent glass and formed in a rectangular shape that is smaller than the upper surface of the housing body 110. In the present embodiment, an A3-sized original sheet 90 can be placed on the transparent portion 114.

In the present embodiment, a direction along a shorter side of the transparent portion 114 is defined as an X direction; a direction along a longer side of the transparent portion 114 is defined as a Y direction; and the direction perpendicular to the X and Y directions is defined as a Z direction. In the present embodiment, a positive X direction extending from the lower right side of FIG. 1 to the upper left side of FIG. 1 is defined as a left direction; a negative X direction extending from the upper left side of FIG. 1 to the lower right side of FIG. 1 is defined as a right direction; a positive Y direction extending from the upper right side of FIG. 1 to the lower left side of FIG. 1 is defined as a front direction; and a negative Y direction extending from the lower left side of FIG. 1 to the upper right side of FIG. 1 is defined as a back direction.

The cover 120 is capable of covering and uncovering the original sheet holder 112. In the present embodiment, the cover 120 is larger than the transparent portion 114 and attached to the housing body 110 through a shaft.

The image reading unit 140 scans the original sheet 90 placed on the transparent portion 114 of the original sheet holder 112 to optically read the original sheet 90. Referring to FIG. 2, the image reading unit 140 includes an imaging unit 150 and a moving unit 160. The imaging unit 150 images rectangular regions AR included in the transparent portion 114. The moving unit 160 moves the imaging unit 150 substantially along the transparent portion 114.

Each rectangular region AR, which can be imaged by the imaging unit 150, is smaller than the transparent portion 114. The moving unit 160 moves the imaging unit 150 in a first scanning direction (along the X direction) and in a second scanning direction (along the Y direction) and places the imaging unit 150 at a position at which the imaging unit 150 faces the transparent portion 114. Thus, the image scanner 10 is capable of imaging the entire region of the transparent portion 114 by means of the imaging unit 150.

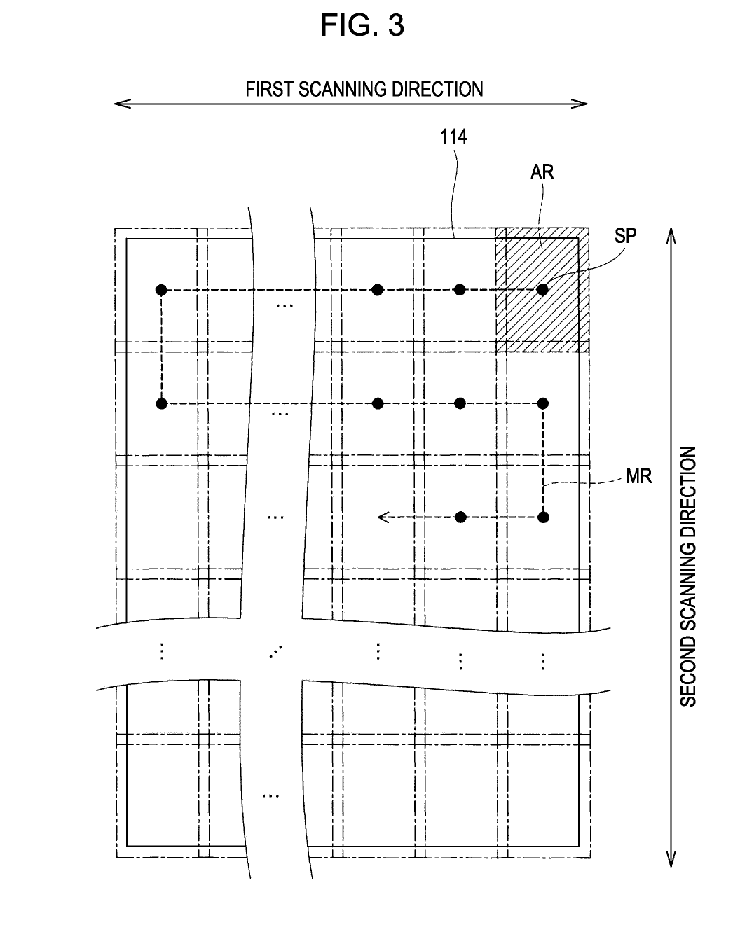

FIG. 3 is a diagram showing positional relationships between the transparent portion 114 and the rectangular regions AR. In FIG. 3, each of the rectangular regions AR (that can be imaged by the imaging unit 150) overlaps an upper surface of the transparent portion 114 when viewed from the top side of the transparent portion 114. In FIG. 3, a movement route MR along which the imaging unit 150 moves is shown by a broken line, and stop positions SP at which the imaging unit 150 stops to image the rectangular regions AR are shown by black circles.

As shown in FIG. 3, each rectangular region AR overlaps other rectangular regions AR adjacent to the rectangular region AR so that the rectangular regions AR are arranged in a matrix form. The total area of the rectangular regions AR is slightly larger than the area of the transparent portion 114. The rectangular regions AR cover the entire surface of the transparent portion 114. In the present embodiment, eighteen rectangular regions AR are arranged in the first scanning direction, and seventeen rectangular regions AR are arranged in the first scanning direction.

To read the A3-sized original sheet 90 placed on the transparent portion 114, the imaging unit 150 images all the rectangular regions AR. In this case, the movement route MR starts from the rectangular region AR located on the rightmost and backmost side of the transparent portion 114 and extends in the first scanning direction (left direction) to the rectangular region AR located on the leftmost and backmost side of the transparent portion 114. Scanning (right-to-left scanning) is performed (on the rectangular regions AR arranged in a first row) in the first scanning direction (left direction) from the rectangular region AR located on the rightmost and backmost side of the transparent portion 114 to the rectangular region AR located on the leftmost and backmost side of the transparent portion 114, as shown in FIG. 3. The movement route MR then extends from the rectangular region AR located on the leftmost and backmost side of the transparent portion 114 to the rectangular region AR located adjacent to and on the front side of the rectangular region AR located on the leftmost and backmost side of the transparent portion 114. After the right-to-left scanning, scanning (left-to-right scanning) is performed (on the rectangular regions AR arranged in a second row) in the first scanning direction (right direction) from the rectangular region AR located on the leftmost side of the transparent portion 114 in the second row to the rectangular region AR located on the rightmost side of the transparent portion 114 in the second row. The movement route MR then extends from the rectangular region AR located on the rightmost side of the transparent portion 114 in the second row to the rectangular region AR located adjacent to and on the front side of the rectangular region AR located on the rightmost side of the transparent portion 114 in the second row. In this way, the right-to-left scanning and the left-to-right scanning are alternately repeated so that the movement route MR extends through all the rectangular regions AR included in the transparent portion 114.

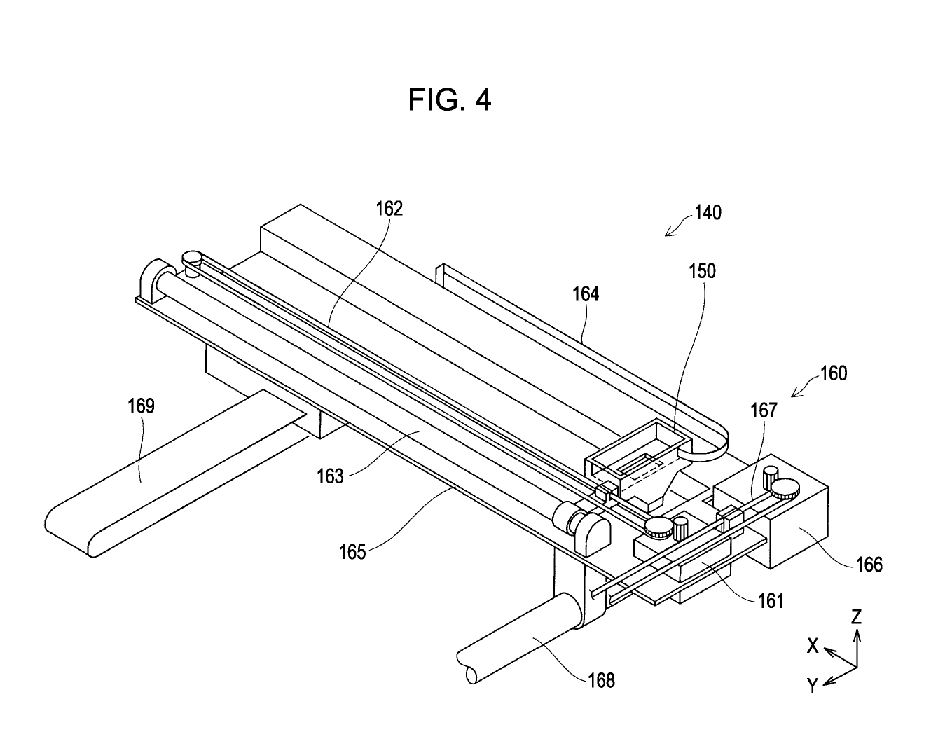

FIG. 4 is a perspective view showing the configuration of the image reading unit 140 in detail. The imaging unit 150 is attached to the moving unit 160 and is capable of moving relative to the original sheet holder 112 in the first and second scanning directions. The moving unit 160 includes a first driving section 161, a first timing belt 162, a first movable shaft 163, a flexible flat cable 164, a carriage 165, a second driving section 166, a second timing belt 167, a second movable shaft 168 and a flexible flat cable 169.

The first driving section 161, the first timing belt 162, the first movable shaft 163 and the imaging unit 150 are mounted on the carriage 165. The carriage 165 is capable of moving relative to the original sheet holder 112 in the second scanning direction. The carriage 165 is attached to the housing body 110 and serves as a transfer stage.

The first driving section 161 is attached to the carriage 165 and drives the moving unit 160 through the first timing belt 162 so that the moving unit 160 moves in the first scanning direction. In the present embodiment, the first driving section 161 includes a step motor that operates on the basis of a control signal transmitted from the main controller 130. The first movable shaft 163 is attached to the carriage 165 and supports the imaging unit 150 that reciprocates in the first scanning direction. In the present embodiment, the first movable shaft 163 extends in the first scanning direction and is a cylindrical metal shaft. The flexible flat cable 164 is located between the imaging unit 150 and the carriage 165 and electrically connects the imaging unit 150 (that reciprocates in the first scanning direction) to the main controller 130.

The second driving section 166 is located in the housing body 110. The second driving section 166 drives the carriage 165 through the second timing belt 167 so that the carriage 165 moves in the second scanning direction. In the present embodiment, the second driving section 166 includes a step motor that operates on the basis of a control signal transmitted from the main controller 130. The second movable shaft 168 is located in the housing body 11 and supports the carriage 165 that reciprocates in the second scanning direction. In the present embodiment, the second movable shaft 168 extends in the second scanning direction and is a cylindrical metal shaft. The flexible flat cable 169 is located between the carriage 165 and the main controller 130 and electrically connects the carriage 165 (that reciprocates in the second scanning direction) to the main controller 130.

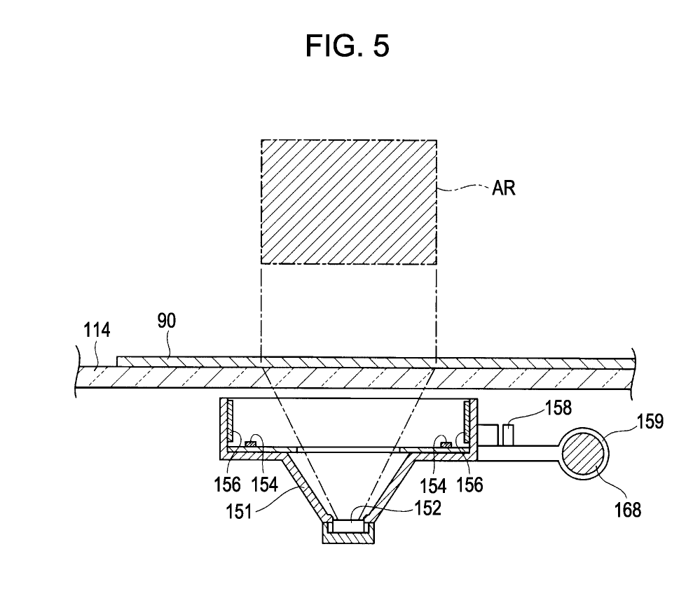

FIG. 5 is a diagram showing the configuration of the imaging unit 150 in detail. FIG. 5 is a cross sectional view of the imaging unit 150 taken along the second scanning direction (Y direction). The imaging unit 150 includes an imaging unit housing 151, an area sensor 152, a light emitting section 154, a reflecting mirror 156, a belt engaging section 158 and a bearing section 159.

The imaging unit housing 151 houses the area sensor 152 and the light emitting section 154. The imaging unit 151 serves as a transfer stage and is attached to the carriage 165 and capable of moving relative to the original sheet holder 112 in the first scanning direction.

The light emitting section 154 is located inside the imaging unit housing 151 and serves as an irradiation device that irradiates the original sheet 90 (placed in the rectangular regions AR) with light. In the present embodiment, the light emitting section 154 emits light toward the transparent portion 114 on the basis of an instruction transmitted from the main controller 130 and in synchronization with the operation for imaging each rectangular region AR. In the present embodiment, the light emitting section 154 includes a light emitting diode mounted on a printed board.

The area sensor 152 is located inside the imaging unit body 151. The area sensor 152 receives light reflected from the original sheet 90 placed in the rectangular regions AR and converts the received light into an electric signal to generate imaging data on the imaged rectangular regions AR. In the present embodiment, the area sensor 152 is an image sensor having charge-coupled devices arranged in a matrix form. In other embodiments of the invention, the area sensor may be an image sensor having other imaging elements such as complimentary metal oxide semiconductors.

The belt engaging section 158 is located outside the imaging unit housing 151. The belt engaging section 158 is engaged with the first timing belt 162 to serve as a part of a power transmission mechanism that receives power transmitted from the first driving section 161. The bearing section 159 is located outside the imaging unit housing 151. The bearing section 159 is mounted on the first movable shaft 163 so that the imaging unit housing 151 is held by the first movable shaft 163.

Returning to FIG. 2, the main controller 130 is electrically connected to the image reading unit 140, the device interface 180 and the user interface 190 and controls each part of the image scanner 10. The main controller 130 includes an image reading controller 810 that controls the image reading unit 140. In the present embodiment, each function of the image reading controller 810 is implemented by a central processing unit (CPU) operating on the basis of a program. In other embodiments, at least one of the functions of the image reading controller 810 may be implemented by an electronic circuit (of the main controller 130) operating on the basis of a physical configuration of the circuit.

The image reading controller 810 includes a route selector 812, a movement controller 814, an imaging controller 816 and an image generator 818. The route selector 812 selects, on the basis of the original sheet 90 (placed on the transparent portion 114 of the original sheet holder 112), the movement route MR along which the imaging unit 150 is moved by the moving unit 160. The movement controller 814 controls the moving unit 160 on the basis of the movement route MR selected by the route selector 812 so that the moving unit 160 moves the imaging unit 150 along the selected movement route MR. The imaging controller 816 controls the imaging unit 150 in synchronization with the movement of the imaging unit 150 controlled by the movement controller 814 so that the imaging unit 150 images the rectangular regions AR. The image generator 818 generates image data on the original sheet 90 (placed on the transparent portion 114 of the original sheet holder 112) on the basis of the imaging data on the rectangular regions AR imaged by the imaging unit 150.

The device interface 180 transmits and receives information to and from an external device (such as a personal computer or a storage device) that is different from the image scanner 10. In the present embodiment, the device interface 180 complies with the universal serial bus (USB) standard. In other embodiments, the device interface 180 may be connected to a network.

The user interface 190 exchanges information with a user of the image scanner 10. In the present embodiment, the user interface 190 includes an operation button that is to be pressed by the user. In other embodiments, the user interface 190 may further include an image display section that displays information to allow the user to view the displayed information.

### Operations of Image Scanner

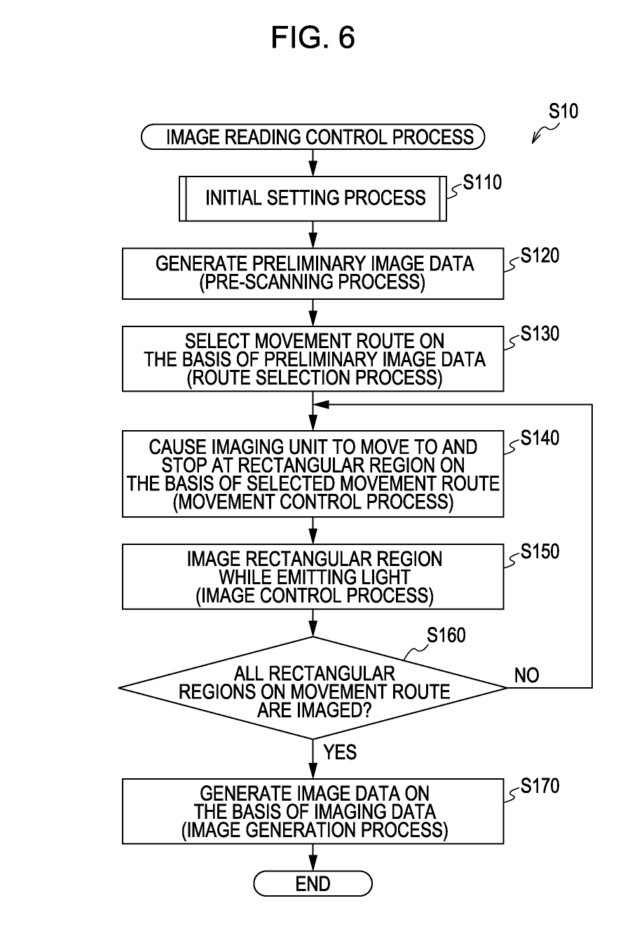

FIG. 6 is a flowchart of an image reading control process (step S10) that is performed by the main controller 130. The image reading control process (step S10) is performed by the image reading controller 810 included in the main controller 130. In the present embodiment, when the user enters a reading instruction through the user interface 190 under the condition that the original sheet 90 is placed on the original sheet holder 112, the main controller 130 starts the image reading control process (step S10).

When the image reading control process (step S10) starts, the main controller 130 performs an initial setting process (step S110). In the initial setting process (step S110), the main controller 130 controls the image reading unit 140. In the present embodiment, the main controller 130 controls the intensity and distribution of light emitted by the light emitting section 154 and controls the black level of a signal that is to be output from the area sensor 152. After that, the main controller 130 controls the imaging unit 150 so that the imaging unit 150 moves to an initial position. In the present embodiment, the initial position to which the imaging unit 150 moves in the initial setting process (step S110) corresponds to the position of the rectangular region AR located on the rightmost and backmost side of the transparent portion 114. In other words, the imaging unit 150 located at the initial position faces the rectangular region AR located on the rightmost and backmost side of the transparent portion 114.

After the initial setting process (step S110), the main controller 130 performs a pre-scanning process (step S120) by operating as a preliminary image generator. In this case, the pre-scanning process (step S120) is performed in order to detect the shape of the original sheet 90 before a main scanning process for properly reading the original sheet 90. In addition, the pre-scanning process (step S120) is performed for a time shorter than the time required for the main scanning process. In the pre-scanning process (step S120), the main controller 130 generates preliminary image data on the entire transparent portion 114 imaged with resolution lower than that used for the main scanning process in the present embodiment. In other embodiments, the main controller 130 may generate the preliminary image data on the entire transparent portion 114 by causing the imaging unit 150 to image every other adjacent rectangular region AR included in the transparent portion 114 in the pre-scanning process (step S120).

After the pre-scanning process (step S120), the main controller 130 performs a route selection process (step S130) by means of a function of the route selector 812. In the route selection process (step S130), the main controller 130 selects the movement route MR for the original sheet 90 by detecting the shape of the original sheet 90 on the basis of the preliminary image data generated in the pre-scanning process (step S120).

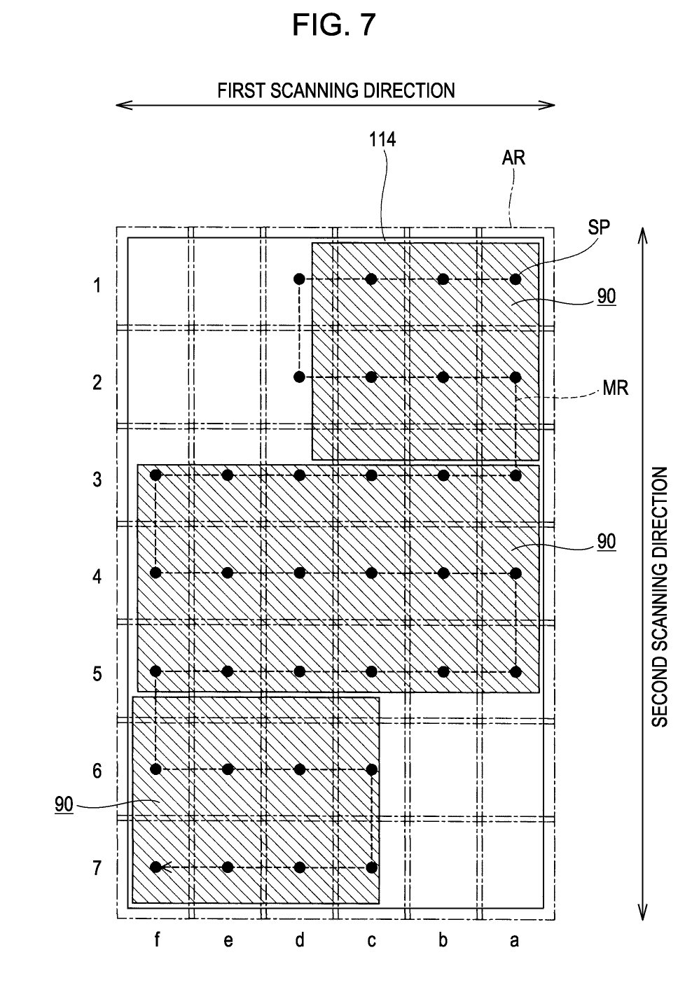

FIG. 7 is a diagram showing an example of the movement route MR selected in the route selection process (step S130). The number of the rectangular regions AR shown in FIG. 7 is smaller than the actual number of the rectangular regions AR in order to avoid complexity of the drawing and simplify the transparent portion 114. The movement route MR is described below using the simplified transparent portion 114.

In FIG. 7, the rectangular regions AR are arranged in seven rows and six columns. Thus, the number of the rectangular regions AR shown in FIG. 7 is 42. The row in which the rectangular regions AR are arranged in the first scanning direction and on the backmost side of the transparent portion 114 is defined as the first row. The row in which the rectangular regions AR are arranged in the first scanning direction and adjacent to the rectangular regions AR arranged in the first row is defined as the second row. The row in which the rectangular regions AR are arranged in the first scanning direction and adjacent to and on the front side of the rectangular regions AR arranged in the second row is defined as the third row. In the same way, the fourth to seventh rows are defined. In addition, the column in which the rectangular regions AR are arranged in the second scanning direction and on the rightmost side of the transparent portion 114 is defined as a column a. The column in which the rectangular regions AR are arranged in the second scanning direction and adjacent to the rectangular regions AR arranged in the column a is defined as a column b. The column in which the rectangular regions AR are arranged in the second scanning direction and adjacent to and on the left side of the rectangular regions AR arranged in the column b is defined as a column c. In the same way, columns d to f are defined. In this specification, the symbol AR is used to generally indicate the rectangular regions AR, and the symbol AR with a row number and column number is used to indicate a specified one of the rectangular regions AR. For example, a symbol AR1a is used to indicate the rectangular region arranged in the first row and column a, and a symbol AR5d is used to indicate the rectangular region arranged in the fifth row and column d.

In the example shown in FIG. 7, three original sheets 90 are placed on the transparent portion 114. One of the three original sheets 90 is located in the rectangular regions AR arranged in the first and second rows and columns a to d. Another one of the three original sheets 90 is located in the rectangular regions AR arranged in the third to fifth rows and columns a to f. The other one of the three original sheets 90 is located in the rectangular regions AR arranged in the sixth and seventh rows and columns c to f.

In the present embodiment, after the main controller 130 detects the original sheets 90 shown in FIG. 7 on the basis of the preliminary image data generated in the pre-scanning process (step S120), the main controller 130 operates as a first selector to select the movement route MR so that the movement route MR includes a route extending along the rectangular regions AR in which the three original sheets 90 are located on the transparent portion 114.

The movement route MR selected in the example shown in FIG. 7 starts from the rectangular region AR1a and extends to the rectangular region AR1d in the first scanning direction (left direction). Then, the movement route MR extends from the rectangular region AR1d to the rectangular region AR2d in the second scanning direction (front direction). Then, the movement route MR extends from the rectangular region AR2d to the rectangular region AR2a in the first scanning direction (right direction). The movement route MR then extends to the rectangular region AR3a in the second scanning direction (front direction). The movement route MR then extends from the rectangular region AR3a to the rectangular region AR3f in the first scanning direction (left direction). Then, the movement route MR extends to the rectangular region AR4f in the second scanning direction (front direction). The movement route MR then extends from the rectangular region AR4f to the rectangular region AR4a in the first scanning direction (right direction) and extends from the rectangular region AR4a to the rectangular region AR5a in the second scanning direction (front direction). The movement route MR then extends from the rectangular region AR5a to the rectangular region AR5f in the first scanning direction (left direction) and extends from the rectangular region AR5f to the rectangular region AR6f in the second scanning direction (front direction). The movement route MR then extends from the rectangular region AR6f to the rectangular region AR6c in the first scanning direction (right direction). The movement route MR then extends from the rectangular region AR6c to the rectangular region AR7c in the second scanning direction (front direction) and extends from the rectangular region AR7c to the rectangular region AR7f in the first scanning direction (left direction). Thus, the rectangular regions AR1e, AR1f, AR2e, AR2f, AR6a, AR6b, AR7a and AR7b are not included in the movement route MR.

Returning back to FIG. 6, the main controller 130 performs a movement control process (step S140) by means of a function of the movement controller 814 after the route selection process (step S130). In the movement control process (step S2140), the main controller 130 controls the moving unit 160 on the basis of the movement route MR selected in the route selection process (step S130) so that the moving unit 160 moves the imaging unit 150 along the selected movement route MR. In the present embodiment, the main controller 130 outputs a control signal to the moving unit 160 so that the imaging unit 150 moves to and stops at a stop position SP corresponding to each rectangular region AR included in the selected movement route MR.

After the movement control process (step S140), the main controller 130 performs an imaging control process (step S150) by means of a function of the imaging controller 816. In the imaging control process (step S150), the main controller 130 controls the imaging unit 150 in synchronization with the movement of the imaging unit 150 controlled in the movement control process (step S140) so that the imaging unit 150 images each rectangular region AR. In the present embodiment, the main controller 130 outputs a control signal to the imaging unit 150 under the condition that the imaging unit 150 is in a stationary state and located at the stop position SP so that the area sensor 152 images the rectangular region AR while the light emitting section 154 emits light toward the transparent portion 114.

After the imaging control process (step S150), the main controller 130 alternately repeats the movement control process (step S140) and the imaging control process (step S150) until all the rectangular regions AR included in the movement route MR are imaged (NO in step S160).

After all the rectangular regions AR included in the movement route MR are imaged (YES in step S160), the main controller 130 performs an image generation process (step S170) by means of a function of the image generator 818. In the image generation process (step S170), the main controller 130 generates image data on the original sheet 90 (placed on the transparent portion 114 of the original sheet holder 112) on the basis of the imaging data on the rectangular regions AR imaged by the imaging unit 150.

In the example shown in FIG. 7, the main controller 130 images the rectangular regions AR1a to AR1d, AR2a to AR2d, AR3a to AR3f, AR4a to AR4f, AR5a to AR5f, AR6c to AR6f and AR7c to AR7f in the imaging control process (step S150). After that, the main controller 130 combines the imaging data on the rectangular regions AR to generate image data on the three original sheets 90 placed on the transparent portion 114 of the original sheet holder 112 in the image generation process (step S170).

### Effects

The image scanner 10 described above is capable of moving the imaging unit 150 along the movement route MR selected on the basis of the original sheets 90 and reading the original sheets 90. The movement route MR is selected on the basis of the original sheets 90 to allow the original sheets 90 to be efficiently read. Thus, the rate of reading the original sheets 90 can be improved.

The main controller 130 controls the imaging unit 150 so that the imaging unit 150 images each rectangular region AR while being in a stationary state and located at the stop position SR corresponding to the rectangular region AR. Thus, a failure in which the area sensor 152 does not image the original sheets 90 can be avoided.

The main controller 130 controls the light emitting section 154 so that the light emitting section 154 emits light toward the transparent portion 114 in synchronization with the operation for imaging the rectangular region AR. Thus, consumption power required for illuminating the original sheets 90 can be suppressed compared with consumption power required for continuously illuminating the original sheet during the operation for reading the original sheet.

Each of the rectangular regions AR overlaps other rectangular regions AR adjacent to the rectangular region AR. Thus, reproducibility of the original sheets 90 can be improved by the image data formed by combining the imaging data on the rectangular regions AR.

In the route selection process (step S130), the main controller 130 selects the movement route MR on the basis of the preliminary image data generated in the pre-scanning process (step S120). The main controller 130 can detect the original sheets 90 on the basis of the preliminary image data. Thus, the main controller 130 can easily select the movement route MR.

In the route selection process (step S130), the main controller 130 selects the movement route MR that extends in the rectangular regions AR (included in the transparent portion 114) in which the original sheets 90 are located. Thus, the main controller 130 controls the imaging unit 150 so that the imaging unit 150 does not move to the rectangular regions AR (included in the transparent portion 114) in which the original sheets 90 are not located. Therefore, the rate of reading the original sheets 90 can be improved.

### First Modified Example

The image scanner 10 according to a first modified example of the first embodiment uses a route selection method (for selecting the movement route MR in the route selection process (step S130)) different from the route selection method described in the first embodiment. The other parts and operations of the image scanner 10 according to the first modified example are the same as the image scanner 10 according to the first embodiment. In the first modified example, the main controller 130 operates as a second selector to select, on the basis of the shape of the original sheet 90, the movement route MR including a route extending along the rectangular regions AR that are continuously arranged in the first or second scanning direction in the route selection process (step S130).

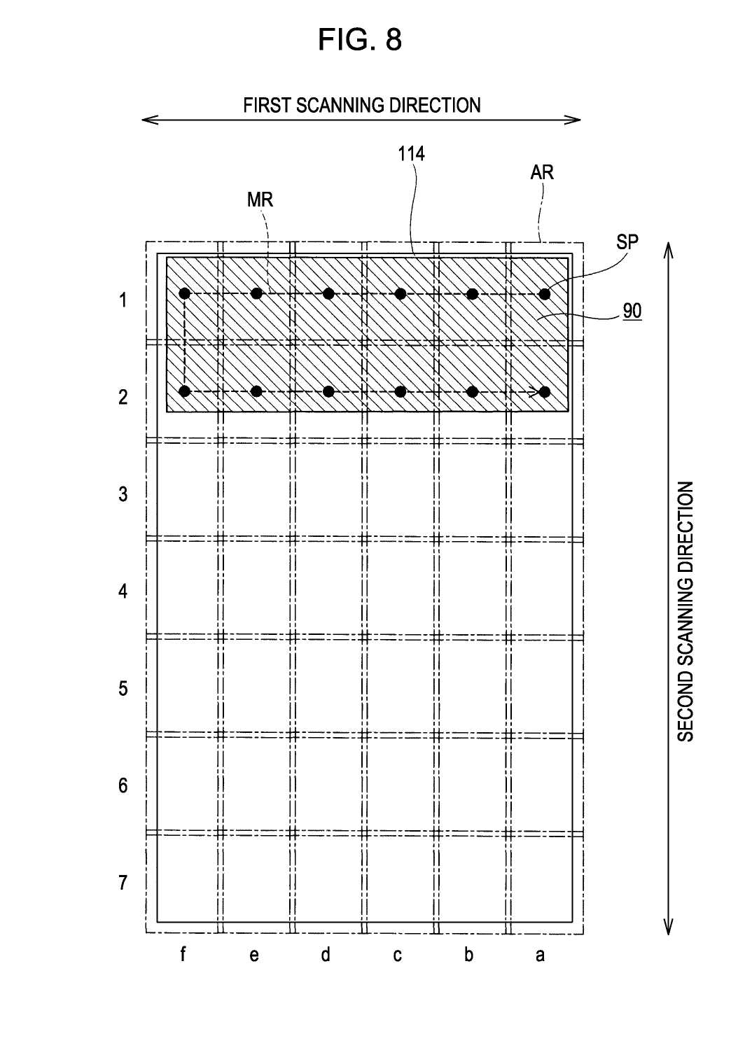

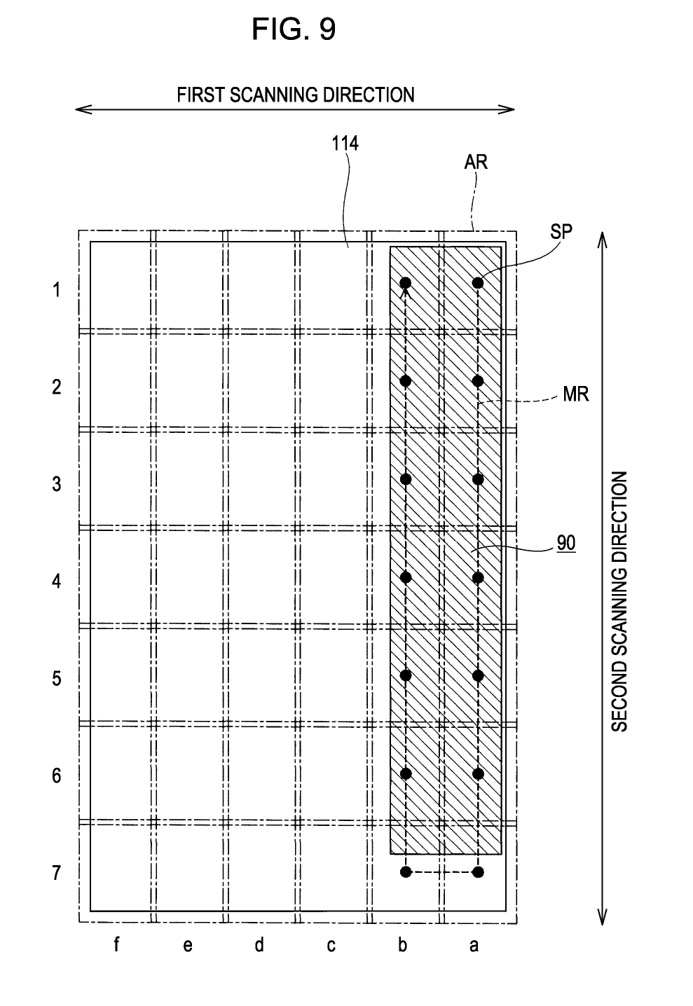

FIGS. 8 and 9 are diagrams each showing an example of the movement route MR selected in the route selection process (step S130) in the first modified example. FIGS. 8 and 9 illustrate the movement routes MR in the same way as FIG. 7.

In the example shown in FIG. 8, a single original sheet 90 is placed on the transparent portion 114. The original sheet 90 shown in FIG. 8 is rectangular and has longer sides extending in the first scanning direction. The original sheet 90 is placed in the rectangular regions AR arranged in the first and second rows and columns a to f. The movement route MR selected in the example shown in FIG. 8 starts from the rectangular region AR1a and extends to the rectangular region AR1f in the first scanning direction (left direction). The movement route MR then extends from the rectangular region AR1f to the rectangular region AR2f in the second scanning direction (front direction) and extends from the rectangular region AR2f to the rectangular region AR2a in the first scanning direction (right direction). The movement route MR shown in FIG. 8 includes the routes extending in the first scanning direction on the basis of the original sheet 90 having the longer sides extending in the first scanning direction.

In the example shown in FIG. 9, a single original sheet 90 is placed on the transparent portion 114. The original sheet 90 shown in FIG. 9 is rectangular and has longer sides extending in the second scanning direction. The original sheet 90 is placed in the rectangular regions AR arranged in the first to seventh rows and columns a and b. The movement route MR selected in the example shown in FIG. 9 starts from the rectangular region AR1a and extends to the rectangular region AR7a in the second scanning direction (front direction). The movement route MR then extends from the rectangular region AR7a to the rectangular region AR7b in the first scanning direction (left direction) and extends from the rectangular region AR7b to the rectangular region AR1b in the second scanning direction (back direction). The movement route MR shown in FIG. 9 includes the routes extending in the second scanning direction on the basis of the original sheet 90 having the longer sides extending in the second scanning direction.

The image scanner 10 according to the first modified example described above is capable of continuously moving the imaging unit 150 in a direction based on the shape of the original sheet 90 placed on the transparent portion 114. Thus, the rate of reading the original sheet 90 can be further improved.

### Second Modified Example

The image scanner 10 according to a second modified example of the first embodiment uses a route selection method (for selecting the movement route MR in the route selection process (step S130)) different from the route selection method described in the first embodiment. The other parts and operations of the image scanner 10 according to the second modified example are the same as the image scanner 10 according to the first embodiment. In the second modified example, the main controller 130 operates as a third selector to select the movement route MR that includes a route extending along a straight line connecting the position of the imaging unit 150 to the position of the original sheet 90 placed on the transparent portion 114 in the route selection processing (step S130).

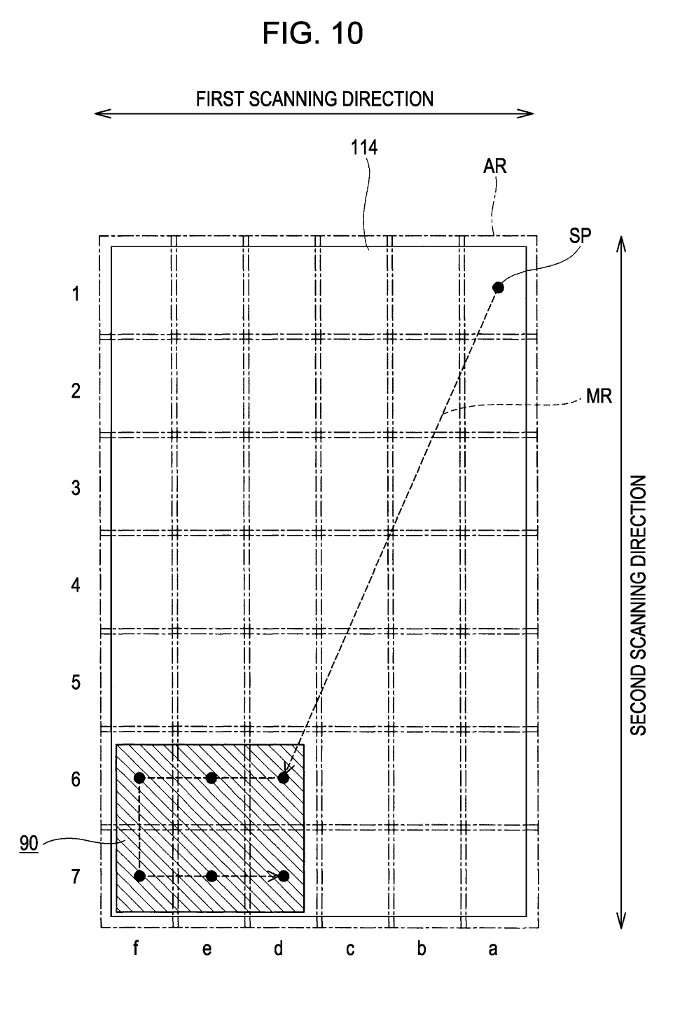

FIG. 10 is a diagram showing an example of the movement route MR selected in the route selection process (step S130) in the second modified example. FIG. 10 illustrates the movement route MR in the same way as FIG. 7.

In the example shown in FIG. 10, a single original sheet 90 is placed on the transparent portion 114. The original sheet 90 shown in FIG. 10 is placed in the rectangular regions AR arranged in the sixth and seventh rows and columns d to f. Thus, the original sheet 90 is separated from the rectangular region AR1a that is the start point of the imaging unit 150. The movement route MR selected in the example shown in FIG. 10 starts from the rectangular region AR1a and linearly extends from the rectangular region AR1a (in which the imaging unit 150 is located) to the rectangular region AR6d (in which the original sheet 90 is located). The movement route MR then extends from the rectangular region AR6d to the rectangular region AR6f in the first scanning direction (left direction). The movement route MR then extends from the rectangular region AR6f to the rectangular region AR7f in the second scanning direction (front direction) and extends from the rectangular region AR7f to the rectangular region AR7d in the first scanning direction (right direction). Thus, the movement route MR includes the linear route connecting the rectangular region AR1a (in which the imaging unit 150 is located) to the rectangular region AR6d (in which the original sheet 90 is located).

The image scanner 10 according to the second modified example described above is capable of moving the imaging unit 150 a relatively short distance in a region (of the transparent portion 114) in which the original sheet 90 is not located. Thus, the rate of reading the original sheet 90 can be further improved.

### Second Embodiment

The image scanner 10 according to a second embodiment of the invention operates in a different manner from the image scanner 10 according to the first embodiment when the image scanner 10 according to the second embodiment performs an image reading control process. The other parts and operations of the image scanner 10 according to the second embodiment are the same as the image scanner 10 according to the first embodiment. In the second embodiment, the main controller 130 selects the movement route MR for the original sheet 90 placed on the transparent portion 114 on the basis of the imaging data on the rectangular regions AR imaged by the imaging unit 150 during the movement of the imaging unit 150 by the moving unit 160.

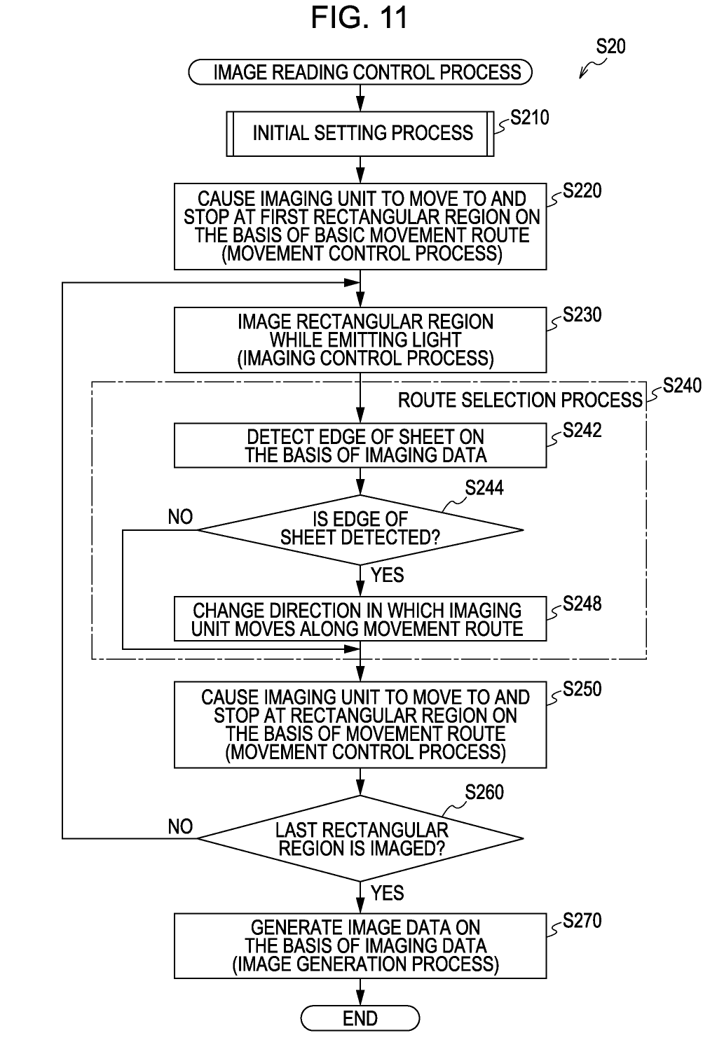

FIG. 11 is a flowchart of the image reading control process (step S20) that is performed by the main controller 130 included in the image scanner 10 according to the second embodiment. The reading control process (step S20) is performed by the image reading controller 810 included in the main controller 130. In the present embodiment, when the user enters a reading instruction through the user interface 190 under the condition that the original sheet 90 is placed on the original sheet holder 112, the main controller 130 starts the image reading control process (step S20).

When the image reading control process (step S20) starts, the main controller 130 performs an initial setting process (step S210) in the same way as the first embodiment.

After the initial setting process (step S210), the main controller 130 performs a movement control process (step S220) by means of the function of the movement controller 814. In the movement control process (step S220), the main controller 130 causes the imaging unit 150 to move to the first rectangular region AR for a basic movement route MR and stop at the first rectangular region AR. In the present embodiment, the basic movement route MR indicates the movement route MR shown in FIG. 3, and the first rectangular region AR indicates the rectangular region AR located on the rightmost and backmost side of the transparent portion 114.

After the movement control process (step S220), the main controller 130 performs an imaging control process (step S230) in the same way as the first embodiment. In the imaging control process (step S230), the main controller 130 outputs a control signal to the imaging unit 150 so that the light emitting section 154 emits light toward the transparent portion 114 while the area sensor 152 images the rectangular regions AR.

After the imaging control process (step S230), the main controller 130 performs a route selection process (step S240) by means of the function of the route selector 812. In the route selection process (step S240), the main controller 130 selects the movement route MR for the original sheet 90 placed on the transparent portion 114 on the basis of the imaging data on the rectangular regions AR imaged by the imaging control process (step S230). In the present embodiment, the main controller 130 detects, on the basis of the imaging data on the rectangular regions AR imaged in the imaging control process (step S230), an edge of the original sheet 90 using a known image detection technique (step S242). When the main controller 130 detects the edge of the original sheet 90 (YES in step S244), the main controller 130 changes the direction in which the imaging unit 150 moves along the movement route MR (step S248). When the main controller 130 does not detect the edge of the original sheet 90 (NO in step S244), the main controller 130 maintains the direction in which the imaging unit 150 moves along the movement route MR.

In the example shown in FIG. 7, the movement route MR starts from the rectangular region AR1a and extends in the first scanning direction (left direction). Since an edge of the original sheet 90, which is located in the direction toward which the imaging unit 150 moves along the movement route MR, is not located in the rectangular regions AR1a to AR1c (NO in step S244), the main controller 130 does not change the basic movement route MR in the route selection process (step S240). Since the edge of the original sheet 90, which is located in the direction toward which the imaging unit 150 moves along the movement route MR, is located in the rectangular region AR1d, the main controller 130 detects the edge of the original sheet 90 in the route selection process (step S240). After that, the main controller 130 changes the direction in which the imaging unit 150 moves along the movement route MR (step S248) so that the movement route MR extends from the rectangular region AR1d through the rectangular region AR2d to the rectangular region AR2c.

After the route selection process (step S240), the main controller 130 performs a movement control process (step S250) by means of the function of the movement controller 814. In the movement control process (step S250), the main controller 130 controls the moving unit 160 on the basis of the movement route MR selected in the route selection process (step S240) so that the moving unit 160 moves the imaging unit 150 along the selected movement route MR.

After the movement control process (step S250), the main controller 130 repeatedly performs the imaging control process (step S230), the route selection process (step S240) and the movement control process (step S250) until the last rectangular region AR is imaged (NO in step S260). In the present embodiment, the last rectangular region AR is either the rectangular region AR located on the leftmost and foremost side of the transparent portion 114 or the rectangular region AR in which the imaging of all edges of the original sheets 90 is completed.

After the last rectangular region AR is imaged (YES in step S260), the main controller 130 performs an image generation process (step S270) in the same way as the first embodiment. In the image generation process (step S270), the main controller 130 generates, on the basis of the imaging data on the rectangular regions AR imaged by the imaging unit 150, image data on the original sheets 90 placed on the transparent portion 114 of the original sheet holder 112.

The image scanner 10 according to the second embodiment described above is capable of moving the imaging unit 150 along the movement route MR selected on the basis of the original sheets 90 and reading the original sheets 90. The movement route MR is selected on the basis of the original sheets 90 to allow the original sheets 90 to be efficiently read. Thus, the rate of reading the original sheets 90 can be improved.

In the route selection process (step S240), the main controller 130 selects the movement route MR for the original sheets 90 placed on the transparent portion 114 on the basis of the imaging data on the rectangular regions AR imaged by the imaging unit 150. Thus, the main controller 130 is capable of selecting the movement route MR while reading the original sheets 90.

### Third Embodiment

The image scanner 10 according to a third embodiment of the invention performs an image reading control process in a different way from the image scanner 10 according to the first embodiment. Other parts and operations of the image scanner 10 according to the third embodiment are the same as the image scanner 10 according to the first embodiment. In the third embodiment, the main controller 130 selects the movement route MR for the original sheet 90 placed on the transparent portion 114 on the basis of information on the shape of the original sheet 90.

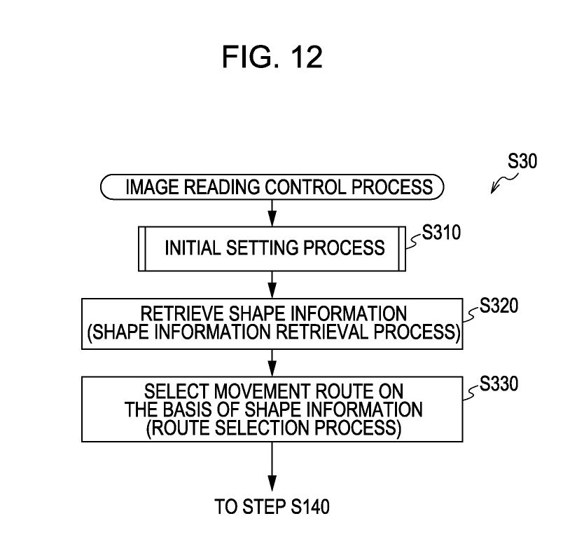

FIG. 12 is a flowchart of the image reading control process (step S30) that is performed by the main controller 130 included in the image scanner 10 according to the third embodiment. The image reading control process (step S30) is performed by the image reading controller 810 included in the controller 130. In the present embodiment, when the user enters an reading instruction through the user interface 190 under the condition that the original sheet 90 is placed on the original sheet holder 112, the main controller 130 starts the image reading control process (step S30).

When the image reading control process (step S30) starts, the main controller 130 performs an initial setting process (step S310) in the same way as the first embodiment.

After the initial setting process (step S310), the main controller 130 performs a shape information retrieval process (step S320). In the shape information retrieval process (step S320), the user interface 190 serves as a shape information receiver and receives shape information entered by the user. The shape information indicates the shape of the original sheet 90. In the shape information retrieval process (step S320), the main controller 130 retrieves the shape information through the user interface 190.

After the shape information retrieval process (step S320), the main controller 130 performs a route selection process (step S330) by means of the function of the route selector 812. In the route selection process (step S330), the main controller 130 selects the movement route MR on the basis of the shape information retrieved in the shape information retrieval process (step S320). When the shape information indicates that the size of the original sheet is A4, the main controller 130 specifies rectangular regions AR that include the rectangular region AR located on the rightmost and backmost side of the transparent portion 114 and are continuously arranged in the first and second scanning directions and have an area corresponding to the size of the A4-sized original sheet 90. The main controller 130 then selects the movement route MR that extends in the specified rectangular regions AR.

After the route selection process (step S330), the main controller 130 performs the movement control process (step S140) and the subsequent processes included in the image reading control process (step S10).

The image scanner 10 according to the third embodiment described above is capable of moving the imaging unit 150 along the movement route MR for the original sheet 90 and reading the original sheet 90. The movement route MR is selected on the basis of the original sheet 90 to allow the original sheet 90 to be efficiently read. Thus, the rate of reading the original sheet 90 can be improved.

In the route selection process (step S330), the main controller 130 selects the movement route MR for the original sheet 90 placed on the transparent portion 114 on the basis of the shape information retrieved in the shape information retrieval process (step S320). Thus, the main controller 130 can detect the shape of the original sheet 90 on the basis of the shape information and easily select the movement route MR.

### Other Embodiments

The embodiments of the invention are described above. The invention is not limited to the embodiments and may be applied to another embodiment without departing from the spirit of the invention.

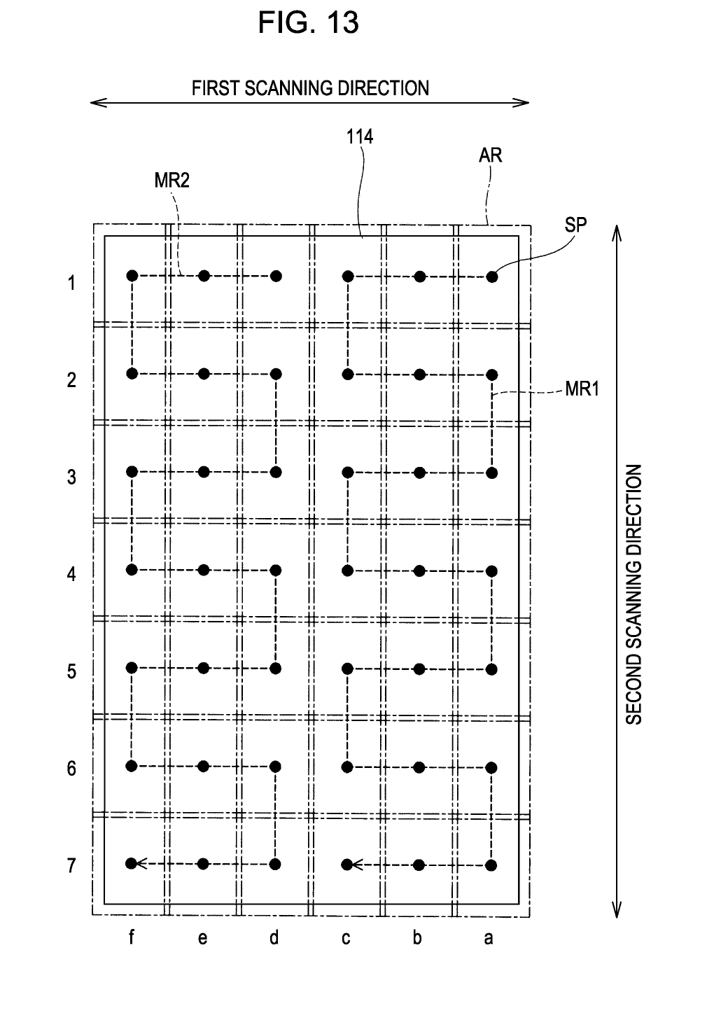

The embodiments of the invention describe the image scanner having the single image reading unit 140. In another embodiment, the image scanner may have a plurality of the image reading units 140. FIG. 13 is a diagram showing an example of movement routes MR1 and MR2 according to the other embodiment. FIG. 13 illustrates the movement routes MR1 and MR2 in the same way as FIG. 7. The image scanner described with reference to FIG. 13 has two image reading units 140. Other parts of the image scanner described with reference to FIG. 13 are the same as the image scanner 10 described in the first to third embodiments. The imaging unit 150 included in one of the image reading units 140 moves along the movement route MR1. The imaging unit 150 included in the other of the image reading units 140 moves along the movement route MR2. In the example shown in FIG. 13, the rectangular regions arranged in the columns a to c are imaged by the imaging unit 150 that moves along the movement route MR1, and the rectangular regions arranged in the columns d to f are imaged by the imaging unit 150 that moves along the movement route MR2.

Each of the embodiments describes the flat-bed image scanner. An automatic sheet feeding image scanner or the like may be applied to another embodiment of the invention. In addition, another image reading device such as a facsimile, a copy machine, a combined machine or the like may be applied to the invention.

What is claimed is:

1. An image reading device that optically reads an original sheet, comprising:
an original sheet holder having a flat surface on which the original sheet is placed;
an imaging unit that images a rectangular region that is included in the flat surface and is smaller than the flat surface;
a moving unit that moves the imaging unit substantially along the flat surface in first and second directions that cross each other and places the imaging unit at a plurality of facing positions at which the imaging unit faces the flat surface;
a route selector that selects, on the basis of the original sheet placed on the flat surface, a movement route along which the imaging unit is moved by the moving unit; and
an image generator that generates, on the basis of imaging data on a plurality of rectangular regions that are imaged by the imaging unit and correspond to the respective facing positions, image data on the original sheet placed on the flat surface.

2. The image reading device according to claim 1, wherein
the imaging unit images each rectangular region while stopping at the facing position corresponding to the rectangular region.

3. The image reading device according to claim 1, wherein
the imaging unit includes a light emitting section that emits light toward the flat surface in synchronization with the imaging of each rectangular region.

4. The image reading device according to claim 1, wherein
each rectangular region that is imaged by the imaging unit placed at the facing position corresponding to the rectangular region overlaps other adjacent rectangular regions.

5. The image reading device according to claim 1 further comprising
a preliminary image generator that generates preliminary image data on the flat surface imaged by the imaging unit before the selection of the movement route by the route selector, wherein
the route selector selects, on the basis of the preliminary image data generated by the preliminary image generator, the movement route for the original sheet placed on the flat surface.

6. The image reading device according to claim 1, wherein
the route selector selects, on the basis of imaging data on the rectangular regions that are imaged by the imaging unit during the movement of the imaging unit by the moving unit and correspond to the respective facing positions, the movement route for the original sheet placed on the flat surface.

7. The image reading device according to claim 1 further comprising
a shape information receiver that receives shape information on the shape of the original sheet placed on the flat surface before the selection of the movement route by the route selector, wherein
the route selector selects, on the basis of the shape information received by the shape information receiver, the movement route for the original sheet placed on the flat surface.

8. The image reading device according to claim 1, wherein
the route selector includes a first selector that selects, as at least a part of the movement route, a route that extends along a region in which the original sheet is placed on the flat surface.

9. The image reading device according to claim 1, wherein
the route selector includes a second selector that selects, as at least a part of the movement route, a route that continuously extends in the first or second direction on the basis of the shape of the original sheet placed on the flat surface.

10. The image reading device according to claim 1, wherein
the route selector includes a third selector that selects, as at least a part of the movement route, a route extending along a straight line that extends between the position of the original sheet placed on the flat surface and the position of the imaging unit.

11. An image reading method for optically reading an original sheet, comprising:
placing the original sheet on a flat surface of an original sheet holder;
moving, substantially along the flat surface in first and second directions that cross each other, an imaging unit that images a rectangular region that is smaller than the flat surface, and placing the imaging unit at a plurality of facing positions at which the imaging unit faces the flat surface;
selecting, on the basis of the original sheet placed on the flat surface, a movement route along which the imaging unit moves; and
generating image data on the original sheet placed on the flat surface by combining imaging data on a plurality of rectangular regions that are imaged by the imaging unit and correspond to the respective facing positions.
